(19) United States
(12) Patent Application Publication
(10) Pub. No.: US 2014/0155099 A1
(43) Pub. Date: Jun. 5, 2014

(54) METHOD AND APPARATUS FOR DISPLAYING LOCATION INFORMATION OF CALL SERVICE AREA IN MOBILE TERMINAL

(71) Applicant: Samsung Electronics Co., Ltd., Gyeonggi-do (KR)

(72) Inventor: Jaewan CHO, Gyeonggi-do (KR)

(73) Assignee: Samsung Electronics Co., Ltd., Gyeonggi-do (KR)

(21) Appl. No.: 14/093,827

(22) Filed: Dec. 2, 2013

(30) Foreign Application Priority Data
Nov. 30, 2012 (KR) 10-2012-0137514

(51) Int. Cl. H04W 4/02

(52) U.S. Cl. CPC H04W 4/02
USPC 455/456.3

(57) ABSTRACT

A method is provided including recording, at a mobile terminal, information relating to a service that is provided to the mobile terminal by a communications network; detecting a deterioration of the service that is provided to the mobile terminal by the communications network to a first service level; generating, based on the recorded information, travel directions form a current location of the mobile terminal to a past location of the mobile terminal where the service provided to the mobile terminal by the communications network is expected to improve to a second service level, the second service level having greater communication capabilities than the first service level.

### CLAIM OF PRIORITY

This application claims the benefit under 35 U.S.C. §119(a) from a Korean patent application filed on Nov. 30, 2012 in the Korean Intellectual Property Office and assigned Serial No. 10-2012-0137514, the entire disclosure of which is hereby incorporated by reference.

### BACKGROUND

1. Technical Field

The present disclosure relates to a method and apparatus for displaying location information of a call service area in a mobile terminal, and more particularly, to a method for displaying location path and information of a call service area in a call disablement state in a mobile terminal, and an apparatus thereof.

2. Description of the Related Art

Portable terminals may connect to communications networks to provide various communications services, such as telephony, Internet access, email, and text messaging services. While these networks may in general have high availability, sometimes they experience dead spots in their coverage. When portable terminals enter such dead spots, they may lose their ability to provide certain types of services, such as the ability to make phone calls or the ability to access the Internet. The dead spots may be either temporary or permanent.

Portable terminals may handle the loss of service resulting from a dead spot in a number of ways. For example, when service is lost, the terminals may display a message or icon indicating that service is unavailable. However, while such messages or icons can signal that the terminal is in a dead spot, they do little in a way of informing the user how to exit the dead spot and go to an area where better network coverage is available. Accordingly, the need exists for techniques for providing portable terminal users with information on how to exit temporary or permanent dead spots in network coverage.

### SUMMARY

The present disclosure is provided to address the above-identified need. More specifically, in one aspect, a method is provided comprising: recording, at a mobile terminal, information relating to a service that is provided to the mobile terminal by a communications network; detecting a deterioration of the service that is provided to the mobile terminal by the communications network to a first service level; generating, based on the recorded information, travel directions form a current location of the mobile terminal to a past location of the mobile terminal where the service provided to the mobile terminal by the communications network is expected to improve to a second service level, the second service level being characterized by greater communication capabilities than the first service level.

In another aspect, an electronic device is provided comprising: a memory; and a processor coupled to the memory, the processor being configured to: record in the memory information identifying a state of a service that is provided by a communications network; detect a deterioration of the service that is provided by the communications network to a first service level; generate, based on the recorded information, travel directions form a current location of the processor to a past location of the processor where the service provided by the communications network is expected to improve to a second service level, the second service level being characterized by greater communications capabilities than the first service level.

### BRIEF DESCRIPTION OF THE DRAWINGS

The above features and advantages of the present disclosure will be more apparent from the following detailed description in conjunction with the accompanying drawings, in which:

FIG. 1 is a block diagram of a mobile terminal according to aspects of the disclosure;

FIG. 2 is a flowchart of a process for collecting of information according to aspects of the disclosure;

FIG. 3 is a flowchart of a process for displaying a service guide according to aspects of the disclosure;

FIG. 4 is a diagram of a screen for providing an indication that a service is unavailable according to aspects of the disclosure; and

FIG. 5, FIG. 6, FIG. 7, FIG. 8 and FIG. 9 are diagrams of screens for providing a service guide according to aspects of the disclosure.

### DETAILED DESCRIPTION

Exemplary implementations of the disclosed subject matter are described with reference to the accompanying drawings. The same reference numbers are used throughout the drawings to refer to the same or like parts. Detailed descriptions of well-known functions and structures incorporated herein may be omitted to avoid obscuring subject matter that is considered more pertinent.

As used herein, the term “RSSI value” refers to the strength of a signal received at a mobile terminal from a base station. The RSSI value for a given signal may be inversely proportional to a distance between the mobile terminal and the base station. Additionally or alternatively, the RSSI value for a given signal may depend on a cell density that is associated with the base station. In some instances, the cell density may be a function of the number of subscribers that are connected to the base station.

As used herein, the term “service level” refers to a measure of communications capabilities that are afforded to a communications terminal by underlying network infrastructure. In some implementations, the service level of a service provided to a mobile terminal by a communications network may be based on a state of a connection between the mobile terminal and a base station that is part of the communications network.

By way of example, in some implementations, the service level for a given mobile terminal may be classified into a “no service” service level, a “limited service” service level, and a “service enabled” service level. The “no service” service level corresponds to a state in which the mobile terminal cannot receive signal from any base station (not just base stations of a network that the terminal is subscribed to). When a mobile terminal is experiencing a “no service” service level, that terminal is incapable of performing both emergency phone calls (e.g., calls to a predetermined number such as 911) and ordinary phone calls (e.g., calls to any telephone number).

The “limited service” service level corresponds to a state in which the mobile terminal is denied the ability to establish at least one type of communications session that the terminal is otherwise capable of establishing during normal operation. For example, when a mobile terminal is experiencing a “limited service” service level, that terminal may be capable of performing emergency phone calls only, but not ordinary calls. In some aspects, a “limited service” capability may be gained by the communications terminal from communications networks of which the terminal is not a subscriber.

The “service enabled” service level corresponds to a state in which the mobile terminal has access to all network services that the terminal receives during normal operation. In some implementations, the “service enabled” service level may correspond to a state in which the terminal is capable of making both ordinary phone calls and emergency phone calls. Moreover, in some implementations, the service enabled level may be classified into a weak electric field service level and a strong electric field service level in dependence upon the RSSI value associated with a signal from a base station that provides the service.

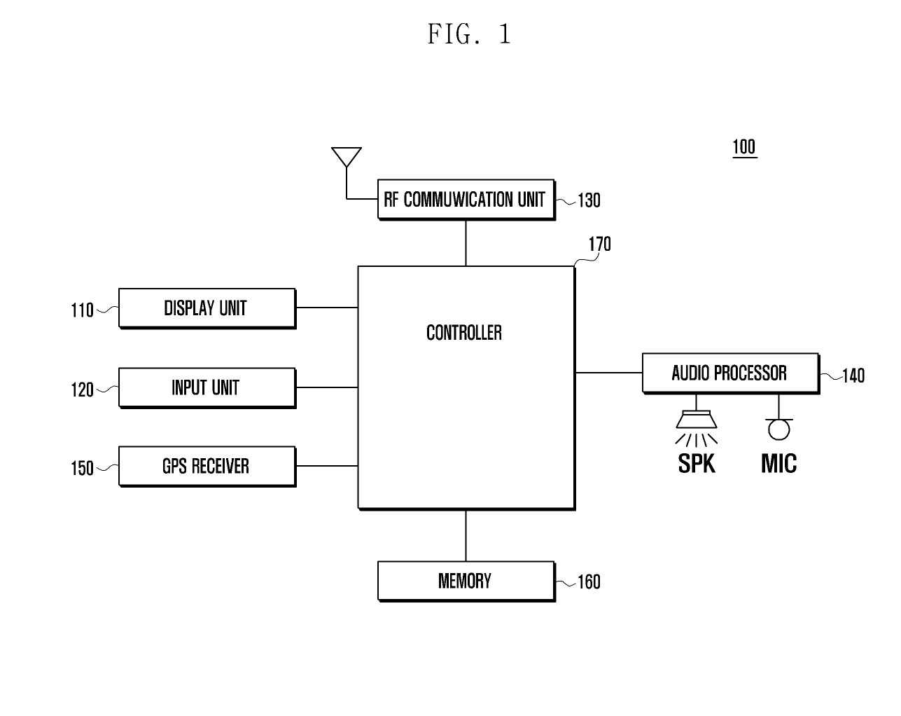

FIG. 1 is a block diagram of a mobile terminal 100 according to aspects of the disclosure. The mobile terminal may include a mobile phone, a smart phone, a tablet PC, a hand-held PC, a Portable Multimedia Player (PMP), or a Personal Digital Assistant (PDA), and/or any other electronic device that is capable of connecting to a communications network.

Referring to FIG. 1, the mobile terminal 100 may include a display unit 110, an input unit 120, a radio frequency (RF) communication unit 130, an audio processor 140, a GPS receiver 150, a memory 160, and a controller 170.

The display unit 110 displays information input by the user or information provided to the user as well as various menus of the mobile terminal 100. The display unit 110 may provide various screens according to use of the mobile terminal 100. The display unit 110 may provide a menu screen, a message writing screen, a call screen, a game screen, a music playback screen, and a moving image playback screen. The display unit 110 may be configured in the form of a flat panel display such as a Liquid Crystal Display (LCD), an Organic Light Emitted Diode (OLED), and Active Matrix Organic Light Emitted Diode (AMOLED).

In some aspects of the disclosure, when the mobile terminal 100 is beyond a communication service area, the display unit 110 may output a call disablement screen to report a “no service” service level to the mobile terminal's user. By way of example, the display unit 110 may display a specific icon indicating that no service is available. Additionally or alternatively, in some aspects of the disclosure, the display unit 110 may display an indication of a travel path leading from the current location of the mobile terminal to an area where increased network service is expected to be available.

The input unit 120 may include a module associated with an input of the mobile terminal 100. The input unit 120 receives an input signal and various character information associated with setting of functions of the mobile terminal and forwards the received information to the controller 170. The input unit 120 may include one or more of a touch pad, a touch screen, a key pad of a general key array, a QWERTY type key pad, a function key set to perform a specific function, a microphone (e.g. microphone MIC or another one) and/or any other suitable input device, or combination thereof.

In some implementations, the input unit 120 may include a touch panel that is integrated into the display unit 110. The touch panel may convert variation in pressure applied to a specific region of the display unit 110 or capacitance occurring at a specific region of the display unit 110 into an electrical input signal. The touch panel may be classified into an add-on type touch panel which is placed on the display unit 110 and an on-cell type touch panel or an in-cell type touch panel which is embedded in the display unit 110. A resistive type, a capacitive type, electromagnetic induction type, and a pressure type are applicable as the touch panel. The touch panel may detect a touched location and area and pressure upon touch. When there is a touch input for the touch panel, the touch panel transmits a corresponding input signal to the controller 170.

The RF communication unit 130 may include an RF transmitter for up-converting a frequency of a transmitted signal and amplifying the converted signal, and an RF receiver for low-noise-amplifying a frequency of a received signal and down-converting the amplified signal. The RF communication unit 130 may include a mobile communication module (e.g., 3-generation mobile communication module, 3.5-generation mobile communication module, or 4-generation mobile communication module, etc.), and a digital broadcasting module (e.g., DMB module). In some aspects of the disclosure, the controller 170 may use the RF communication unit 130 to access various services provided by a communications network, such as telephony services, Internet access, map downloading services, and/or any other suitable type of service.

The audio processor 140 may perform Digital-to-Analog (DA) conversion of data received from the controller 170 and feed the resultant signal to a speaker SPK. Furthermore, the audio processor 140 may perform Analog-to-Digital (AD) conversion of signals received from a microphone MIC and provide the resultant digital audio data to the controller 170.

A Global Positioning System (GPS) receiver 150 receives a GPS satellite signal from a GPS satellite and transfers the GPS satellite signal to the controller 170. The controller 170 may calculate location coordinates of the mobile terminal using the GPS receiver 150. Further, the controller 170 may use the coordinates to determine an address where the mobile terminal is located.

The memory 160 stores various data executed and processed by the mobile terminal 100 as well as an operating system (OS) and various applications of the mobile terminal 100. The memory 160 may include a data area and a program area. The data area of the memory 160 may store data generated by the mobile terminal 100 or downloaded from the outside, and attribute information indicating an attribute of the data according to use of the mobile terminal 100. Further, the data area may store screens displayed on the display unit 110. In addition, the data area may implement a memory clipboard for use in the copying and pasting of data. Moreover, the data area may store various preset values (e.g., screen brightness) for operating the mobile terminal.

The program area of the memory 160 may store an OS for booting the mobile terminal 100 and application programs implementing various functionalities, such as communication functions (e.g., accessing the Internet, conducting phone calls, writing emails, sending text messages), audio and/or video playback functionality, image display functionality, image capturing functionality, media recording functionality, calculator functionality, and a schedule management functionality.

According to aspects of the disclosure, when an RSSI value of a wireless signal received from a base station is less than or equal to a preset threshold value, the memory 160 stores communication state information under the control of the controller 170. By way of example, the communication state information may include location information of the mobile terminal 100, information on whether communication fails, an RSSI value of a wireless communication signal, communication level information according to the RSSI value, service time information, and/or any other suitable type of information.

The controller 170 controls an overall operation of the mobile terminal 100 and signal flow between internal configurations, and processes data. The controller 170 controls power supply to internal elements from a battery. If the power is supplied, the controller 170 controls a booting procedure of the mobile terminal 100, and executes various application programs stored in a program area to execute a function of the mobile terminal according to user setting. In some implementations, the controller may include a processor, such an x86 processor, an ARM processor, a MIPS processor, and/or any other suitable type of processor.

In some aspects, the controller 170 may measure an RSSI value from a wireless communication signal received via the RF communication unit 130. The controller 170 may periodically communicate with a base station to record RSSI values for signals received from the base station. If the RSSI value for a signal received from the base station is less than or equal to a preset threshold value, the controller 170 may collect communication state information. The controller 170 may measure the RSSI value in dB. The preset threshold value may similarly be set as specific dB, but the present disclosure is not limited thereto. For example, if the RSSI value is less than or equal to the preset threshold value, the controller 170 may activate the GPS receiver 150, record location information of the mobile terminal 100, and collect service level information, time information, and the RSSI value, and or any other suitable type of communication state information. Afterwards, if a next RSSI value sample exceeds the preset threshold value, the controller 170 may deactivate the GPS receiver 150, and stop collecting the communication state information.

The controller 170 may determine in various ways whether the mobile terminal is experiencing a “no service” service level or a “limited service” service level. For example, when the RSSI value for a signal from a base station is measurable, but a communication channel with the base station cannot be set, or communication with the base station fails, the controller 170 may recognize its current service level as a “limited service” service level. Additionally or alternatively, if the RSSI value for signal transmitted by the base station cannot be measured, the controller 170 may recognize its current service level as a “no service” service level.

If the communication level of the mobile terminal 100 is the “no service” service level or the “limited service” service level, the controller 170 may cause the display unit 110 to display a corresponding indication of the service level and/or a service guide screen. In some implementations, displaying the service guide screen may include displaying directions from the current location of the mobile terminal to a location where a higher level service is available, such as a location where “limited service” or “service enabled” service levels are provided. Displaying the service guide screen may help the user to find a location in which the user is likely to be able to make either emergency or ordinary phone calls. Although, in this example, directions are presented visually, in other examples they may be presented using audio only, and/or any other suitable medium.

In some implementations, the service guide screen may be generated by controller 170 based on previously-collected communication state information. The controller 170 may generate the service guide screen in a way that relates communication state information with the location where that information was collected. Furthermore, in some implementations, if the user moves or approaches (e.g., if the current location of the user (or mobile terminal) is within a predetermined distance from where emergency phone calls are expected to be possible), the controller 170 may automatically retransmit the emergency call at a time when the emergency call is possible.

Although not shown in FIG. 1, the mobile terminal 100 may include additional components such as a sensor module for detecting orientation of the mobile terminal 100 and a camera module for capturing pictures. Furthermore, specific elements in the foregoing arrangements of the mobile terminal 100 of the present disclosure may be omitted or substituted with other suitable elements. The structure of mobile terminal 100 is provided as an example only as the elements that are customarily included in mobile terminals may change in accordance with various convergence trends.

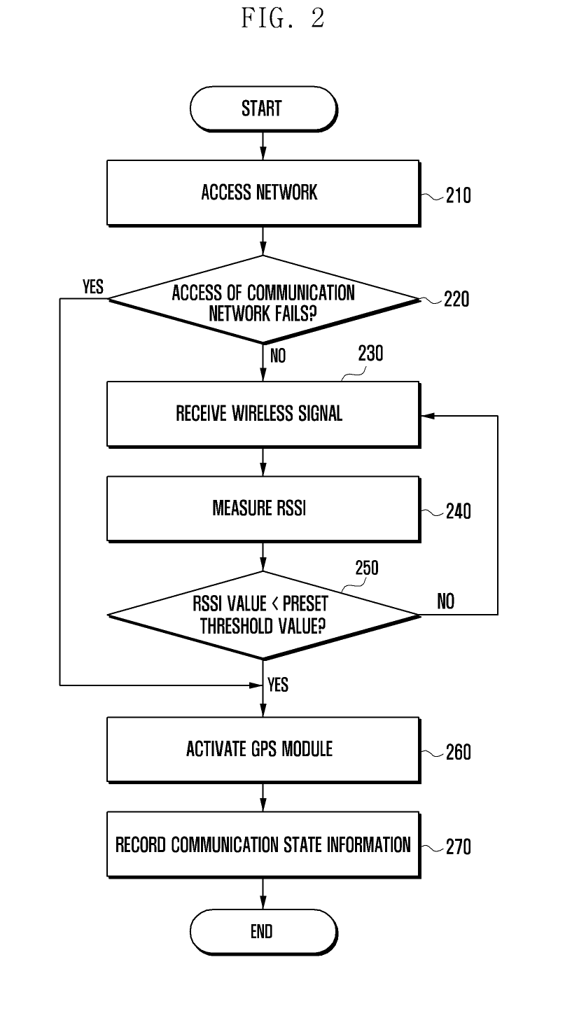

FIG. 2 is a flowchart of a process for collecting information according to aspects of the disclosure. Referring to FIG. 2, a controller 170 attempts to access a wireless communications network through an RF communication unit 130 (210). The controller 170 determines whether the attempt to access the communication network has failed (220). If it is determined that the attempt has failed, the process proceeds to step 260. Otherwise, if it is determined that the attempt to access the communication network is successful, the process proceeds to step 230.

At step 230, the controller 170 accesses the communication network to receive a wireless signal (230). The controller 170 measures an RSSI value from the wireless signal (240). The controller 170 then determines whether the RSSI value is less than a preset threshold value (250). If the RSS value is greater than the predetermined threshold, the process returns to step 230. Otherwise, if the RSS value is less than the predetermined threshold, the process proceeds to step 260.

At step 260, the controller 170 activates the GPS module 150. The controller 170 then collects communication state information and location information (270). In some implementations, the collected information may include information identifying the location of the mobile terminal, a map of the area where the mobile terminal is located, the RSSI value for one or more signals that are received by the mobile terminal, an indication of the service level that at least one base station is capable of providing to the terminal, and/or any other suitable type of information.

In some implementation's, the collected information may be stored in the memory 160 of the mobile terminal. Additionally or alternatively, in some implementations, the communication state information may be transmitted to a base station in a cell and subsequently used to find dead spots in network coverage.

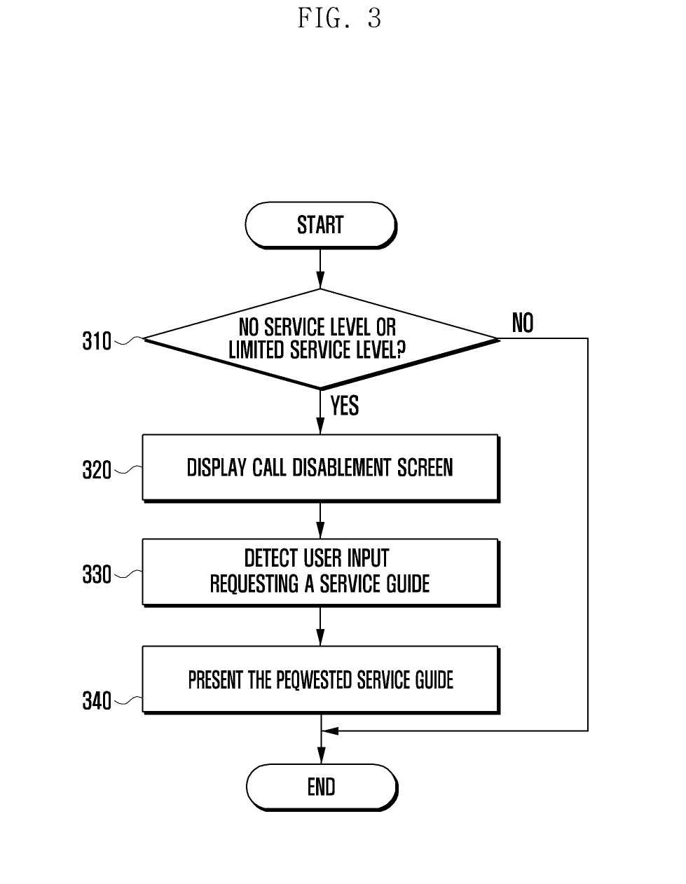

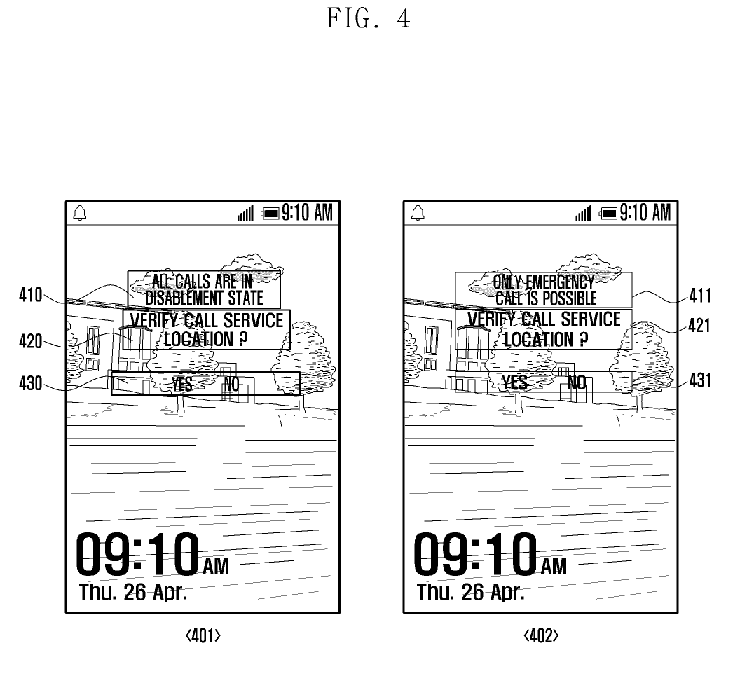

FIG. 3 is a flowchart of a process for displaying a service guide in accordance with aspects of the disclosure. At step 310, the controller 170 determines whether the level of service provided to the mobile terminal 100 is a “no service” service level or a “limited service” service level. By way of example, the determination may be based on at least one of, an RSSI value for a signal transmitted by a base station, a failure to measure an RSSI value for signals transmitted by a base station, a failure to establish a communication channel with the base station, or a breakdown of an established communications channel with the base station. If the service available to the mobile terminal is at one of the “no service” or “limited service” service levels the process proceeds to step 320. Otherwise, the process ends.

At step 320, the controller 170 outputs a call disablement screen on the display unit 110 as shown in FIG. 4. The call disablement screen may be output as a screen 401 or a screen 402 depending on the service level of the service that is available to the mobile terminal. For example, when the mobile terminal is at the “no service” service level, the controller 170 may output a message 410 indicating that no phone calls are possible to make at the moment. Additionally or alternatively, the mobile terminal may display a service guide label 420, and a selection item 430.

In instances where the mobile terminal is at the “limited service” service level, the controller 170 may output a message 411 indicating that only emergency calls are possible. Additionally or alternatively, a service guide label 421, and a selection item 431 may also be displayed by the mobile terminal.

At step 330, the controller 170 detects an input of a user requesting presentation of a service guide screen. For example, the user input may be provided by selecting the “Yes” option in one of the selection items 430 and 431.

At step 340, in response to detecting the user input, the controller 170 outputs a service guide. The output service guide may include at least one of a text message, a drawing, an audio notification, a tactile notification, and/or any other suitable type of notification that identifies or indicates at least one location where the mobile terminal is expected to be able to obtain an improved network service—namely, a service having a service level characterized by greater communications capabilities than the service level available at the current location of the mobile terminal. (E.g., a service providing the ability to make ordinary phone calls when the mobile terminal is able to make only emergency phone calls at its current location).

In some implementations, the location may be a past location of the mobile terminal—namely, a location that was previously visited by the terminal. In some implementations, the location may be selected by the mobile terminal based on being associated with communication state information, collected by the mobile terminal at that location, which indicates that a predetermined level of service was available at that location when the mobile terminal was there. As suggested above, the predetermined service level may be one that is characterized by greater communications capabilities than the service level available at the current location of the mobile terminal.

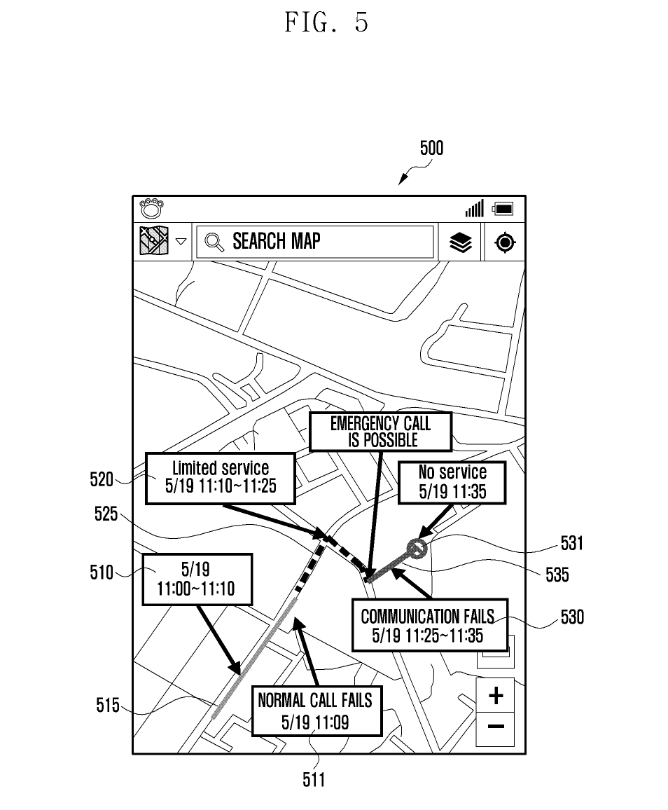

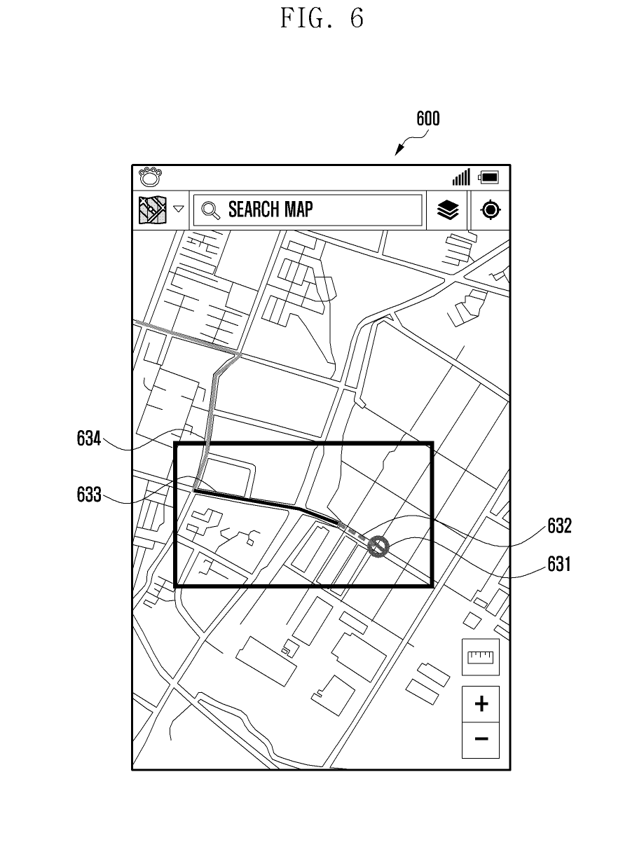

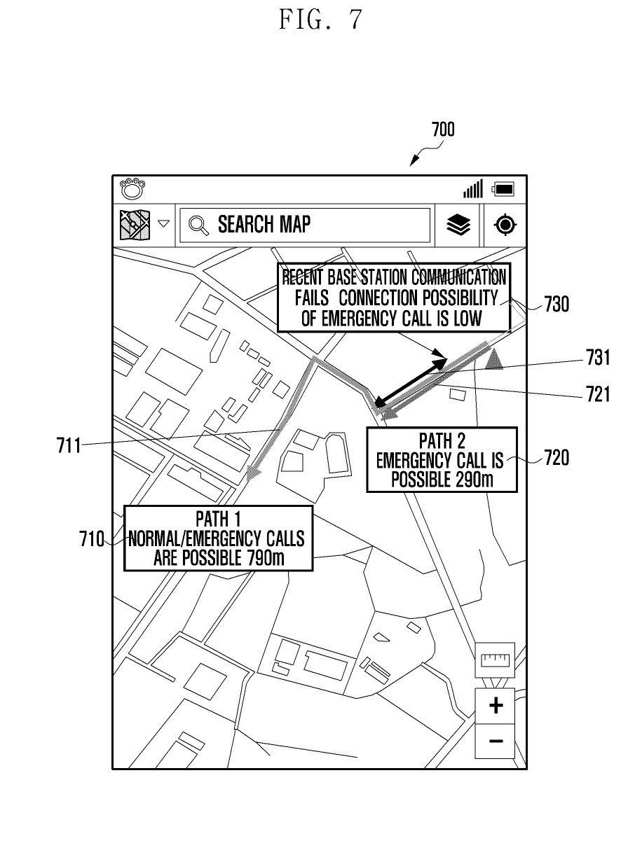

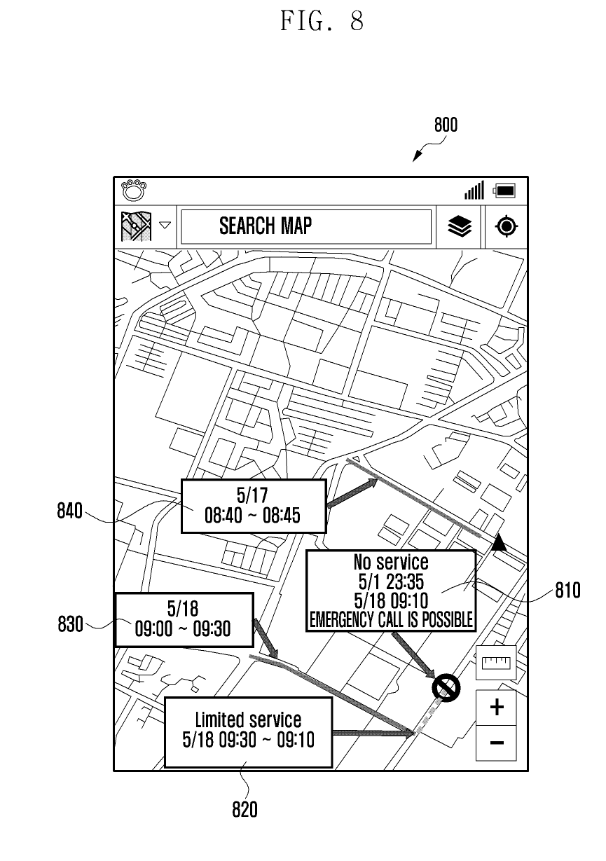

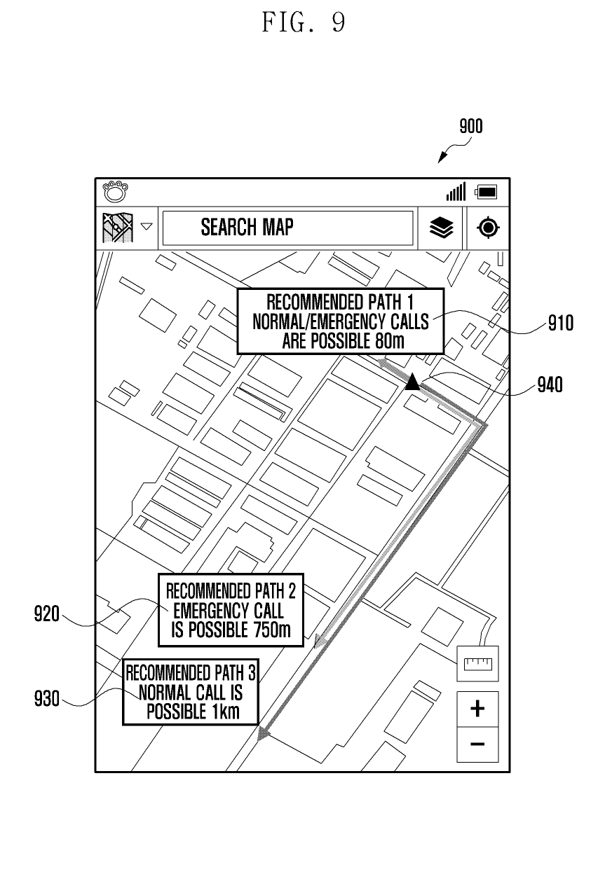

FIG. 5 is a diagram of an example of a service guide screen 500 in accordance with aspects of the disclosure. In some implementations, the service guide may include at least one of a map and an indication of a path that is travelled by the mobile terminal within a predetermined period of time (e.g., in the last 20 minutes.). Furthermore, in some implementations, the path indication may be based one or more items of communication state information that was collected by the mobile terminal while the mobile terminal was travelling the path. By way of example, the service guide may indicate the level of service experienced by the mobile terminal at different sections of the path. The indication of the path may be used to indicate to the user one or more locations where an improved network service is expected to be available.

More specifically, in some implementations, a user input may be received at the mobile terminal requesting directions from the mobile terminal's current location to a location at which the mobile terminal would be able to make an emergency phone call. In response to the user input, the controller 170 may output at least one of an indication of a distance and an indication of a path (or route) between the current location of the mobile terminal and a location where emergency phone calls are expected to be possible to make. Similarly, when user input is received that requests directions to a location where the mobile terminal would be able to make ordinary phone calls, the controller 170 may output an indication of a distance and/or an indication of a path between the current location of the mobile terminal and a location where the making of ordinary phone calls is are expected to be possible. As noted, in some implementations, the user request for a service guide may include an indication of a desired service level.

In some implementations, the indication of the path and/or the indication of the distance may be generated by the controller 170 based on previously collected communication state information. The controller 170 may present at least some of the collected communication state information on a map, thus providing the user of the mobile terminal with a travel path to a location where a desired service level is expected to be available. In addition, the controller 170 may provide an indication of a distance to the location, turn-by-turn directions to the location, and or any other suitable information that might be helpful to the user in the location.

In some implementations, the communications state information may be indicated by varying a color, a shape, a thickness, and/or any other suitable characteristic of a representation of the path. Additionally or alternatively, in some implementations, the controller 170 may vary the way different sections in the path are presented based on the communications state information. For example, as illustrated in FIG. 5, a path may include sections 515, 525, and 535. Section 515 may be displayed using a thin red line to indicate that a “service enabled” level of service was provided to the mobile terminal in that section. Section 525 may be displayed using a dashed line to indicate that a “limited service” level of service was provided to the mobile terminal in that section. And section 535 may be displayed using a thick black line to indicate that “no service” level of service was provided in that section. As noted above, each section of the path may correspond to a route travelled by the mobile terminal in the past.

Furthermore, in some implementations, the service guide screen 500 may include labels 510, 520, and 530. As illustrated, in this example, label 510 may indicate that normal service was provided to the mobile terminal during the time period between 11:00 and 11:10. Label 520 may indicate that limited service was provided to the mobile terminal during the time period 11:10-11:25. Similarly, label 530 may indicate that no service was provided to the mobile terminal during the time period 11:25-11:35. The labels, as noted above, may be generated based on communications state information that was recorded by the controller 170 during the identified time periods.

In addition, the service guide screen 500 may provide a label 511 indicating that a phone call in which the terminal participated was disrupted at 11:09. Furthermore, as shown, the service guide screen 500 may include a marker 531 of the mobile terminal's current location.

FIG. 6 is diagram of an example of a service guide screen 600 in accordance with aspects of the disclosure. In this example, a path is displayed that indicates the travel route of the mobile terminal along with a marker 631 that indicates the mobile terminal's current location. The travel path, as shown, includes sections 632, 633, and 634. Each section is displayed differently in dependence upon the level of service that was available in that section when the section was last traveled by the mobile terminal. For example, section 632 may be depicted as a dashed line to indicate that no service was available in that section. Section 633 may be depicted as a thick black line to indicate that limited service was available in that section. Similarly, section 634, may be depicted as a thin red line to indicate that full service was available in that section. Thus, in this example, the service guide screen 600 may indicate that the user will likely be unable to make any type of phone call if the user is located anywhere along section 632. Furthermore, the service guide 600 may indicate that if the user wants to make an emergency phone call, the user ought to travel to section 633. And still furthermore, the service guide 600 may indicate that if the user wants to be able to make ordinary phone calls, the user ought to travel to section 634. Although in this example the different sections indicate availability of a telephony service, in other examples they may indicate availability of another type of service (e.g., Internet Access, 3G Internet access, 4G Internet access, etc.).

FIG. 7 is a diagram of an example of a service guide screen 700 in accordance with aspects of the disclosure. As shown, a first path 710 and 711, a second path 720 and 721, and a third path 730 and 731 may be concurrently displayed. The first path may denote locations in which both normal and emergency calls are possible. The second path may denote locations in which only the emergency call are possible. And the third path 731 may be also output, but may be output as communication service information 730 with respect to the third path. That is, the controller 170 may set to output one moving path by determining a recommended priority with respect to each path based on a distance to a communication service area according to the location of the user. In this state, when the user selects the first path, the controller 170 controls to enlarge a map suited to a distance between a current location and a call enablement point and to perform a navigation function.

FIG. 8 is a diagram of an example of a service guide screen 800 in accordance with aspects of the disclosure. As shown, the service guide screen 800 may include a map identifying different service levels measured by the controller 170 at different times. For example, a path 810 may be displayed denoting locations on the map where no service was available on May 1^{st} and where limited service was available on May the 18^{th}. By contrast, path 820 may denote locations on the map where limited service was available on May 18^{th} only. In addition, paths 830 and 840 may denote areas on the map where full service was available on May the 18^{th} and May the 17^{th}, respectively. In other words, path 810 may be generated based on communications state information that was collected by the controller 170 during multiple time periods, while each of paths 820, 830, and 840 may be generated based on information collected during a single time period.

FIG. 9 is a diagram of an example of a service guide screen 900 in accordance with aspects of the disclosure. According to this example, paths 910, 920, and 930 may be displayed on a map of the service guide screen 900, such that each path leads to a location where a different level of service is available. For example, paths 910 and 930 may lead to locations where a “service enabled” level of service is available. Path 920, on the other hand, may lead to a location where a “limited service” level of service is available. The current location of the processor 170 is denoted by marker 940 on the map.

In some implementations, the paths may be user selectable. For example, each one of paths may be selectable by an input gesture, such as a tap. When one of the paths is selected, the controller 170 may zoom in the map, center the map on the selected path, and output turn-by-turn directions for following the selected path. Furthermore, in some implementations, if the user moves and approaches an area in which an emergency call can be made, that is—a limited service level area, the mobile terminal may automatically initiate an emergency call.

FIGS. 2 and 3 are provided as examples only. In some implementations, steps depicted in those figures can be performed concurrently or altogether omitted. Although the above techniques, the service guide and the path contained herein are presented visually, in some implementations, the path may be presented using audio, as spoken turn-by-turn directions, or in any other suitable manner. In some instances, the mobile terminal may dynamically download a map of its current surroundings as it travels from one location to another. Doing so may ensure that mobile terminal has the map necessary for generating a service guide screen should the need becomes.

Furthermore, in some instances, as noted, the service guide can be generated based on a subset of all communications state information that is stored at the portable terminal. For example, that subset may include information that is collected within a predetermined time period (e.g., last 20 minutes) and/or information that is collected within a predetermined distance from the communications terminal. It should be noted that the above examples are not mutually exclusive and that features disclosed by the different examples may be combined together in various suitable implementations of the present disclosure.

The above-described embodiments of the present disclosure can be implemented in hardware, firmware or via the execution of software or computer code that can be stored in a recording medium such as a CD ROM, a Digital Versatile Disc (DVD), a magnetic tape, a RAM, a floppy disk, a hard disk, or a magneto-optical disk or computer code downloaded over a network originally stored on a remote recording medium or a non-transitory machine readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

Under the broadest reasonable interpretation, the appended claims constitute statutory subject matter in compliance with 35 U.S.C. §101. The definition of the terms “unit” or “module” as referred to herein is to be understood as constituting hardware circuitry such as a processor or microprocessor configured for a certain desired functionality, or a communication module containing hardware such as transmitter, receiver or transceiver, or a non-transitory medium comprising machine executable code that is loaded into and executed by hardware for operation, in accordance with statutory subject matter under 35 U.S.C. §101 and do not constitute software per se.

Although exemplary embodiments of the present disclosure have been described in detail, it should be noted that many variations and modifications of the basic inventive concepts herein taught which may appear to those skilled in the present art will still fall within the spirit and scope of the present disclosure, as defined in the appended claims.

What is claimed is:

1. A method comprising:
recording, at a mobile terminal, information relating to a service that is provided to the mobile terminal by a communications network;
detecting a deterioration of the service that is provided to the mobile terminal by the communications network to a first service level;
generating, based on the recorded information, travel directions from a current location of the mobile terminal to a past location of the mobile terminal.

2. The method of claim 1, wherein the past location of the mobile terminal comprises a location at which the communications network is expected to improve to a second service level, the second service level having greater communication capabilities than the first service level.

3. The method of claim 1, wherein the deterioration of the service is detected based on at least one of a loss of signal from a base station in the communications network, a failure to establish a communications channel with the base station, and a failure to receive from the base station a response to a communication request.

4. The method of claim 2, wherein:
the travel directions include a graphical representation of a travel path having a first section and a second section,
the first section corresponds to a first geographic area where the service provided by the communications network is expected to be at the first service level, and
the second section corresponds to a second geographic area where the service provided by the communications network is expected to be at the second service level.

5. The method of claim 4, wherein the first section differs from the second section in at least one of color, type of line used to represent the first section, or thickness.

6. The method of claim 1, further comprising:
downloading, over the communications network, a map of current surroundings of the mobile terminal, the downloading being performed prior to the deterioration being detected; and
wherein generating the travel directions include drawing on the map a travel path from the current location of the portable terminal to the past location of the portable terminal.

7. The method of claim 1, further comprising outputting by the mobile terminal an indication of a distance between the current location of the mobile terminal and the past location of the mobile terminal.

8. The method of claim 1, wherein the travel directions are generated based on a subset of the recorded information, the subset including information that is collected during a predetermined time period.

9. The method of claim 1, wherein the travel directions are generated based on a subset of the recorded information, the subset including information that is collected within a predetermined distance from the current location of the mobile terminal.

10. The method of claim 1, wherein the recorded information comprises at least one of location information, communication failure information, an RSSI value of a wireless communication signal, service level information, and time information.

11. The method of claim 1, wherein the recorded information comprises an indication of strength of a signal transmitted by a base station that is part of the communications network.

12. An electronic device comprising:
a non-transitory memory; and
a processor coupled to the memory, the processor being configured to:
record in the memory information identifying a state of a service that is provided by a communications network;
detect a deterioration of the service that is provided by the communications network to a first service level;
generate, based on the recorded information, travel directions from a current location of the processor to a past location of the processor.

13. The electronic device of claim 12, wherein the service provided by the communications network is expected to improve to a second service level, the second service level having greater communications capabilities than the first service level.

14. The electronic device of claim 12, wherein the deterioration of the service is detected based on at least one of a loss of signal from a base station in the communications network, a failure to establish a communications channel with the base station, and a failure to receive from the base station a response to a communication request.

15. The electronic device of claim 12, wherein:
the travel directions include a graphical representation of a travel path having a first section and a second section,
the first section corresponds to a first geographic area where the service provided by the communications network is expected to be at the first service level, and
the second section corresponds to a second geographic area where the service provided by the communications network is expected to be at the second service level.

16. The electronic device of claim 14, wherein the first section differs from the second section in at least one of color, type of line used to represent the first section, or thickness.

17. The electronic device of claim 13, wherein the processor is further configured to:
download, over the communications network, a map of current surroundings of the mobile terminal, the downloading being performed prior to the deterioration being detected; and
wherein generating the travel directions include drawing on the map a travel path from the current location of the portable terminal to the past location of the portable terminal.

18. The electronic device of claim 12, wherein the processor is further configured to output an indication of a distance between the current location of the processor and the past location of the processor.

19. The electronic device of claim 13, wherein the travel directions are generated based on a subset of the recorded information, the subset including information that is collected during a predetermined time period.

20. The electronic device of claim 12, wherein the travel directions are generated based on a subset of the recorded information, the subset including information that is collected within a predetermined distance from the current location of the processor.

21. The electronic device of claim 12, wherein the recorded information comprises at least one of location information, communication failure information, an RSSI value of a wireless communication signal, service level information, and time information.

22. The electronic device of claim 12, wherein the recorded information comprises an indication of strength of a signal transmitted by a base station that is part of the communications network.
